(19) United States
(12) Patent Application Publication
(10) Pub. No.: US 2016/0086125 A1
(43) Pub. Date: Mar. 24, 2016

(54) IMPLICIT AND EXPLICIT COLLECTIVE DEFINITION OF LEVEL OF DIFFICULTY FOR METRICS BASED COMPETITIONS IN CALL CENTERS

(71) Applicant: Xerox Corporation, Norwalk, CT (US)

(72) Inventors: Benjamin Vincent Hanrahan, Grenoble (FR); Stefania Castellani, Meylan (FR); Tommaso Colombino, Grenoble (FR); David Rozier, Bernin (FR)

(73) Assignee: Xerox Corporation

(21) Appl. No.: 14/490,925

(22) Filed: Sep. 19, 2014

(51) Int. Cl. G06Q 10/06; H04M 3/51

(52) U.S. Cl. CPC G06Q 10/06398; H04M 3/5175

(57) ABSTRACT

Methods and systems for managing a metric-based competition in a work environment to increase productivity. Information related to a set of participants in a work environment can be received. One or more interfaces can be generated, which allow participants to input data for use in collaboratively defining key performance indicators associated with a proposed competition and based at least in part on the information related to the participants, so as to increase participant motivation by providing the participants with more agency and choice with respect to competitions in the work environment.

### FIELD OF THE INVENTION

Embodiments are generally related to work environments such as call centers. Embodiments also relate to the management of competition in work environments utilizing metric-based technology. Embodiments are additionally related to interfaces utilized in work environments.

### BACKGROUND

Call centers commonly use gaming techniques to motivate agent performance in the workplace. These games may take the form of challenges or competitions, which act as a more interactive alternative to activity-based compensation models and performance management strategies for motivating agents. Activity-based compensation models, for example, allow for individual agent performance to be measured. Such compensation models, however, do not provide contextual information regarding overall call center performance. Properly designed games have the potential to motivate individual agents while also taking into account performance weaknesses and strengths of the entire call center.

The games currently employed by call centers are designed to drive performance according to particular performance metrics or services according to organizational requirements. Because the particular performance metrics and/or services are not changed on a regular basis, the games tend to target the same skill set and consequently the same subset of agents tends to win. Those agents outside of the winning subset may perceive the game as unfair and believe that they do not have a realistic chance to win. Current games are also not implemented in a technological manner. Game scoreboards are typically wall displays that are not updated frequently. Both agents and supervisors lack dynamically updated displays which are beneficial for enhanced situational awareness and engagement between call center agents and supervisors.

Call centers thus need to improve the engagement of their agents. According to observations made in call centers, performance related incentives (such as competitions) are organised with the purpose of improving performance metrics, morale, and engagement of agents. Competitions may pit individual agents, teams, or entire call centres against each other for prizes and rewards, e.g., a few extra minutes break time. Typically, they are tied to specific metrics referred to as Key Performance Indicators (KPIs) such as Average Handle Time (AHT) (typically referring to the total time for handling a call including any wrap-up work for an agent to close the call). For example, a competition could be based on the lowest AHT for a given day or week. KPIs are used as the primary method to assess the agents' work and are also used to determine the levels of compensation at call centres where activity based compensation mechanisms are used.

Typically, competitions in call centres are defined and organized by team supervisors and/or operation managers. Competitions are useful to some extent, but they often have several drawbacks in their current form. One such drawback is that the competitions are used to address the short-term operational needs of the organization and therefore are not particularly sensitive to the performance trends (and strengths and weaknesses) of individual agents or small teams of agents, or to the non-linear relationship between different performance metrics and the dangers of pushing performance aggressively on one metric at the expense of another. Such a problem was discussed in, for example, U.S. Patent Application Publication No. 2014/0192970, entitled “System to Support Contextualized Definitions of Competitions in Call Centers,” which published on Jul. 10, 2014 and is incorporated herein by reference in its entirety.

However, competitions are not just tools to improve performance—games are by definition designed to improve engagement and motivation on the job. In contrast, current competitions are defined without agent involvement (i.e., are imposed on the agents often without giving them the choice whether to participate or not) and are rarely modified. Indeed, while competitions in call centres are presented as games, they lack of agency or choice. Agents, in turn, experience them as an additional performance management strategy rather than a game. In order to resolve this issue and increase agent engagement with these games, we propose a mechanism to involve agents directly in the configuration of competitions, thus reintroducing an element of agency and choice in process. The mechanism is designed to help agents and supervisors collaboratively define competitions according to the current situation/context in the call centre, for example, in terms of the current values for KPIs, or according to the preferences and objectives of the individual agents who are the actual participants of the competitions and the primary contributors to their success.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved method and system for managing competition in work environments.

It is another aspect of the disclosed embodiments to provide for an improved method and system for managing competitions in work environments by allowing participants (e.g., agents) to be involved in their definition.

It is yet another aspect of the disclosed embodiments to provide for improved interfaces for use in managing a work environment.

It is another aspect of the disclosed embodiments to provide for methods and systems.

The aforementioned aspects and other objectives and advantages can now be achieved as described herein. Methods and systems are disclosed for managing a metric-based competition in a work environment to increase productivity. Information related to a set of participants in a work environment can be received. One or more interfaces can be generated, which allow participants to input data for use in collaboratively defining key performance indicators associated with a proposed competition and based at least in part on the information related to the participants, so as to increase participant motivation by providing the participants with more agency and choice with respect to competitions in the work environment.

The disclosed embodiments provide for a mechanism to involve call center agents in the definition of KPI (Key Performance Indicator) related competitions. This approach is based on the observation that, currently, competitions do not sufficiently engage and motivate agents to participate. Such an approach can increase agent motivation and engagement by providing them with more agency and choice with respect to competitions, involving them in the configuration of the competitions. The disclosed embodiments can be implemented to collectively define competitions in work environments such as call centers.

The disclosed embodiments provide for steps or logical operations for implementing an implicit and explicit collective definition of a level of difficulty for a metrics-based competition in a work environment. Steps or logical operations can be implemented for determining their priorities of different KPI's capable of being used, defining the difficulty of the proposed competition, defining the reward (e.g., amount of compensation) associated with the competition, defining the desired output of the competition, and providing the possibility of defining challenges among teams under specific conditions based on levels of progression attained.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a functional block diagram of an example work environment in which a preferred embodiment may be implemented

FIG. 2 illustrates a high-level flow of operations depicting logical operational steps of a method for implementing an implicit and explicit collective definition of a level of difficulty for a metrics-based competition in a work environment, in accordance with a preferred embodiment;

FIG. 3 illustrates an example graphical representation of a visual interface depicting an example of a configuration for a competition based on AHT improvement;

FIG. 4 illustrates a graph depicting data indicative of how the difficulty of a simple competition can be calculated, in an example case;

FIG. 5 illustrates an example interface wherein an operation manager or other user can prioritize KPI's, in accordance with an embodiment;

FIG. 6 illustrates an example interface that allows a participant or agent to select a particular level of difficulty in accordance with an alternative embodiment;

FIG. 7 illustrates an example interface that can be utilized to assist a manager in deciding whether or not to issue a bonus, in accordance with an alternative embodiment:

FIG. 8 illustrates an example interface that allows an agent to vote to accept or reject a bonus, in accordance with an alternative embodiment; and

FIG. 9 illustrates an example interface that can permit visualisation of the progress of a team in work environment competition, in accordance with an alternative embodiment.

### DETAILED DESCRIPTION

The particular values and configurations discussed in these non-limiting examples can be varied and are cited merely to illustrate at least one embodiment and are not intended to limit the scope thereof.

Agent performance in call centers can be measured according to performance metrics, which can be tied to Key Performance Indicators (KPIs). In order to improve the performance metrics as well as the motivation and morale of the agents, many call centers provide incentives in addition to a base salary or activity-based compensation mechanisms, which may take the form of competitions among the agents. Competitions may pit individual agents, teams, or entire call centers against each other for prizes and rewards that range from the nominal (a few extra minutes break time) to the substantial (flat screen TVs and laptops). These competitions are performance related, that is, they are tied to specific KPIs. For example, a competition could be based on the largest improvement of a performance metric for a given day or week.

However, not all agents have the same skill set and not all agents have the same margins for improvement on the same metrics. For example, challenging agents with a low value on a specific performance metric to lower that performance metric even more is not likely to yield significant improvements. The agents are not likely to have margins of improvement on the desired performance metric that will benefit the call center as a whole. They are also unlikely to appreciate being pushed on performance metrics for which they are already performing as expected.

The exemplary system and method can yield improvements to both overall performance of call centers and individual agent motivation. This is particularly due to useful visual indications for contextual game design provided to supervisors, including: current values of correlated performance metrics, the predicted effect when correlated performance metrics are altered, and/or potential success rates of proposed competitions when considering characteristics particular to individual agents. The exemplary system and method assists call center supervisors in visualizing the state of various KPIs, as well as forming competitions at the appropriate time to effect changes in the same KPIs. The functionalities may be applied at different levels of scope, i.e., team, group or call center level. In particular, the method considers aggregated KPIs, i.e., performance metrics that are aggregated (e.g., averaged) over a population (e.g., team) of agents. While reference is often made herein simply to “KPIs”, it is to be appreciated that aggregated KPIs are generally being considered.

The term “supervisor” can be utilized herein to refer to any decision-maker(s) charged with responsibility for monitoring the performance of a group of people and to provide competitions for motivating them appropriately, and may include managers, IT personnel, and the like.

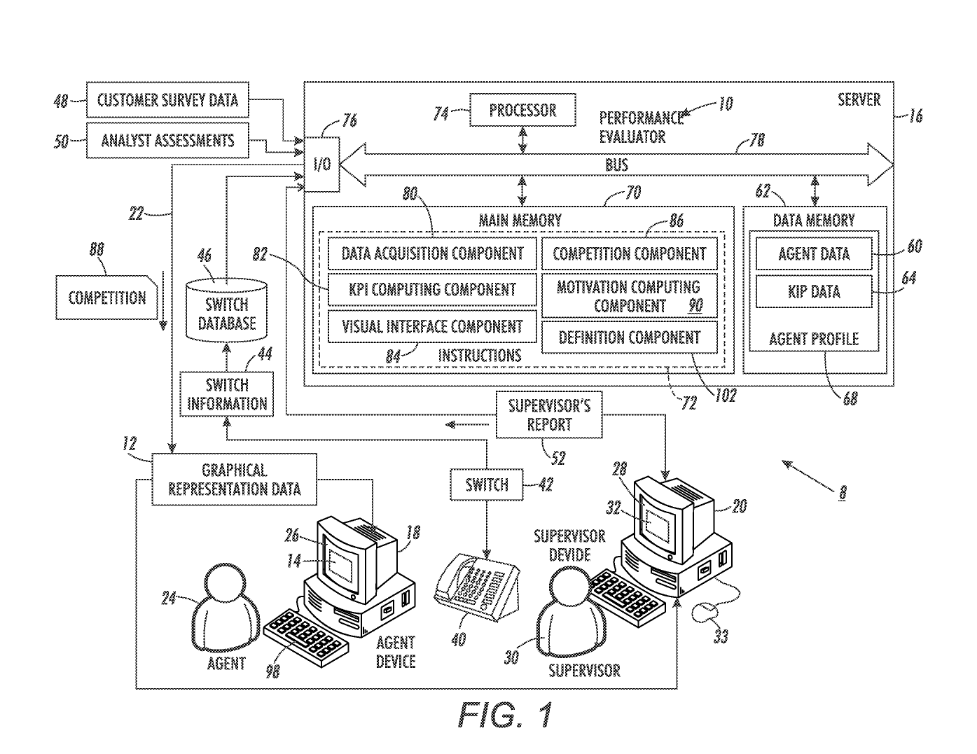

FIG. 1 illustrates a functional block diagram of an example work environment or system 8 in which a preferred embodiment may be implemented. The implicit and explicit collective definition of level of difficulty can be implemented in the context of a metrics-based competition for the work environment or system 8. The system 8 shown in FIG. 1 can include, for example, a server-side and a user side. At the server side, a performance evaluator 10 optionally generates visual interface data 12 for display as an agent visual interface 14. This agent visual interface 14 can display a summary of an agent's performance in relation to the goals of a proposed competition on the client/user side. The performance evaluator 10 can be hosted wholly or partly on a server computing device 16 which communicates with a set of agent client devices 18 and one or more supervisor client devices 20, via a network 22. Only one agent client device 18 is shown for ease of illustration, but it is to be appreciated that a large number of such agent client devices may be linked to the server 16 via the network 22.

The network 22 can be, for example, a wired or wireless network, e.g., a local area network or a wide area network, such as the Internet. The visual agent interface 14 can be displayed to an agent 24 on a display device 26 of the respective client device 18. The performance evaluator 10 is also configured for displaying a similar visual interface 28 to a supervisor 30 for a team of agents on a display device 32 of the respective supervisor client device 20. While the same visual agent interface 14 could be provided to all operators, in the exemplary embodiment, agents 24 on a team are each provided with an individualized representation of their own respective performance characteristics, which is a slightly different visual interface from that received by the supervisor 30 of the team, through which the supervisor can view information which assists in designing competitions which are suitable for motivating a group of agents. The agent visual interface 14 for the agent may show an overall aggregation of the agent's situation in terms of each of a plurality of performance metrics and other characteristics, and their evolution over time.

In some embodiments, the supervisor's visual interface 28 can show the distribution of these characteristics over the team, while also providing access to the information about the individual agents in his or her team. The visual interface 28 also provides a mechanism for designing competitions to improve performance metrics, specifically, to improve performance metrics aggregated over a population of agents, such as the supervisor's team. The supervisor's client device 20 includes a user interface device 33 for inputting commands to the processor and display device 32 of the supervisor's device, which allows the supervisor to interact with the visual interface 28. The user interface device 33 can include, for example, a mouse, joystick, keyboard, keypad, combination thereof, or the like.

Typically, the agent(s) 24 are grouped into a team of 10 to 15 workers to which a supervisor 30 is assigned. The agents may receive periodic (typically weekly and monthly) feedback from the supervisor on their performance. As will be appreciated, a group of supervisors may also have a supervisor, sometimes referred to as an operations manager, who may also be provided with a representation (not shown) analogous to visual interface 28. A large call center may have a “floor” of up to, for example, 800 or 900 agents, or more, operating at the same time.

Each agent can be provided with a telephone device 40 on which he receives incoming calls and/or on which he may be able to initiate calls in some cases. Information 44 about the length of each call and time between calls can be generated, based on the state of a call center switch 42 associated with the telephone, which detects whether the agent's telephone is in use or not. The information 44 may be collected and stored in a switch database 46 in memory accessible to the performance evaluator 10. The performance evaluator 10 may also receive, as input, customer survey data 48, derived from customer reviews of the agent 24 as a result of prior telephone interactions with customers, and/or analysts' assessments 50 made by listening to the agents calls. A supervisor's report 52 on the agent, generated by the agent's supervisor 30, may also be received by the performance evaluator 10.

The exemplary visual interface 28 can provide a supervisor 30 with some or all of the following features:

1. A visualization of the current state of KPIs;

2. Providing alerts to the supervisor 30 when an issue with one or more KPIs is detected;

3. Visualizing the predicted effect on related KPIs when a selected KPI is manipulated on the visual interface 28, in particular, visualizing the effect on aggregated values of each of a set of KPIs, which are aggregated over a population of agents rather than for a single agent;

4. Communicating the difficulty of a proposed competition;

5. Displaying the possible contributions for individual agents to provide an indication of the possible “success” of the competition;

6. Notifying the supervisor 30 of an automatically triggered competition for KPIs that need improvement; and

7. Providing the supervisor 30 with suggestions for altering on-going competitions to fit the needs of the call center better.

As previously noted, the performance of each agent 24 may be measured according to each of a set of KPIs. One or more of the KPIs may be derived, at least in part, directly from the call center telephone switch 42. One or more of the KPIs may be derived, at least in part, from customer survey data 48 and/or the assessments 50 performed by quality analysts who listen to recorded phone calls and “score” the agents' performance on a set of pre-defined categories (e.g., “average”, “very good”, “excellent”).

Examples of KPIs derived from the telephone switch include the Average Handle Time (AHT), which represents the average time an agent spends on a phone call with a customer (or performing a task in other contexts), and the After Call Work time (ACW), which represents the average time between ending one call (task) and starting on the next. Another KPI may be the average transfer rate (T), which represents the average percentage of calls which the agent transfers to another agent or supervisor. A quality (Q) KPI may be based on the customer survey data 48 and/or analyst assessment scores 50. As will be appreciated, these performance measures are intended to be exemplary only. and the system is not limited to any specific measures of the agents' performances. The call center as a whole is typically expected to keep its aggregate average KPI values (aggregated over all the agents) within a certain range defined between upper and lower threshold values (or in some cases, to meet only an upper or a lower threshold value). Agents are therefore in turn expected to manage their phone calls so that their individual average KPI values meet the same thresholds or agent-specific thresholds.

The server side 16 of the exemplary system 8 can provide for the collection and aggregation of the relevant information, e.g., KPI data. For example, agent data 60, which includes the customer survey data 48, information 44 retrieved from the database 46, analyst assessments 50, and supervisor's report 52 (or data derived from these data), may be stored in data memory 62 of the server computer 16. Performance metric (KPI) data 64 is generated by the system, based on the agent data 60, and used by the performance evaluator 10 to generate the graphical agent visual interface 12 and the supervisor interface 28. The agent data 60 and performance metric data 64 for the agent may be stored together with the agent's skill-related information as an agent profile 68.

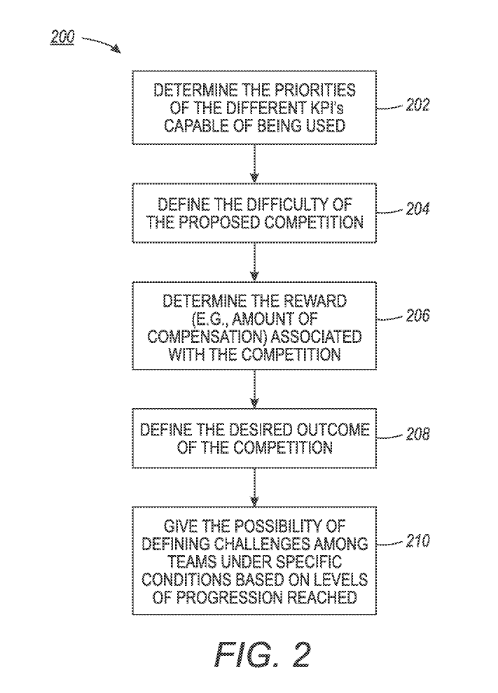

The exemplary server computer 16 may include main memory 70 which stores instructions 72 for implementing the exemplary method described with respect to FIG. 2, and a processor 74, in communication with the memory 70, for executing the instructions. One or more input/output devices 76 may be provided for receiving the data 44, 48, 50, 52 and for outputting the graphical representation data 12 and the like. Hardware components 62, 70, 74, 76 may communicate via a data/control bus 78.

In an exemplary embodiment, memory 70 stores a data acquisition component 80 for acquiring data 44, 48, 50, 52 from various sources and storing it in memory 62, from which the agent data 60 is extracted. A performance metric (KPI) component 82 generates KPI values 64 periodically for the agent individually and aggregated KPI values for the team as a whole, based on the stored agent data 60. A representation generator 84 generates and updates the visual interface data 12 periodically, based on the aggregated KPI values 64 and stored thresholds for the aggregated KPI values, for display on the supervisor's display device. The representation generator 84 may also generate and update the individual agent visual interface data 12 periodically, based on the agent's respective KPI values 64 and stored thresholds for the KPI values.

In one embodiment, a competition component 86 can automatically generate new competitions 88, for example, when the system detects that one or more KPI is approaching a value at which a threshold value for that KPI is not met. This means, for example, that in the case where the KPI threshold is a minimum value, the detected KPI value is exhibiting a trend towards falling below the minimum, which can be based on a recent history of detected values, but may not yet have reached the threshold. Similarly, for a KPI threshold which establishes a maximum KPI value for a particular KPI, the observed trend is towards exceeding the maximum value.

Competitions 88 may also be configured to be automatically triggered by the system when other specific situations are detected. The competitions may first be proposed to the supervisor 30 for validation, or received from the supervisor for presenting to the agent, or a combination thereof.

In another embodiment, a motivation calculating component 90 of the system 8 can calculate the potential individual contributions of individuals. Motivation calculation component 90 may include inputting values for each of a set of explanatory variables into an improvement prediction function. This function outputs a prediction of the amount of improvement that an individual may exhibit when presented with a specified motivation, such as a competition. Main memory can also store a definitions component or module 102 that provides for the implicit and explicit collective definition of the level of difficulty for metrics based competitions in work environments such as call centers.

In some embodiments, the server computer memory 62, 70 may be separate or combined and may represent any type of non-transitory computer readable medium such as random access memory (RAM), read only memory (ROM), magnetic disk or tape, optical disk, flash memory, or holographic memory. In one embodiment, the memory 62, 70 comprises a combination of random access memory and read only memory. In some embodiments, the processor 74 and memory 62 and/or 70 may be combined in a single chip. The network interface 76 allows the computer to communicate with other devices via the computer network 22, such as a local area network (LAN) or wide area network (WAN), or the internet, and may comprise, for example, a modulator/demodulator (MODEM).

The digital processor 74 can be variously embodied, such as by a single-core processor, a dual-core processor (or more generally by a multiple-core processor), a digital processor and cooperating math coprocessor, a digital controller, or the like. The digital processor 74, in addition to controlling the operation of the computer 16, can execute instructions 72 stored in memory 70 for performing the server side operations of the method 200, which is outlined in FIG. 2.

The agent device 18 and supervisor device 20 may be similarly configured to the server computer and may each comprise one or more specific or general purpose computing devices, such as a PC, such as a desktop, a laptop, palmtop computer, portable digital assistant (PDA), server computer, cellular telephone, tablet computer, pager, combination thereof, or other computing device capable of executing instructions for performing the client side operations of the exemplary method. The agent device 18 and supervisor device 20 may have memory, a processor, and an input/output device for communicating with other devices via the network 22. The agent device 18 may also include an agent user input device 98, analogous to user input device, such as a keyboard, keypad, touchscreen, cursor control device, or combination thereof, or the like, for inputting commands to the respective processor and display 14.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 illustrates a high-level flow of operations depicting logical operational steps of a method 200 for implementing an implicit and explicit collective definition of a level of difficulty for a metrics-based competition in a work environment, in accordance with a preferred embodiment. As indicated at block 202, a step or logical operation can be implemented for determining the priorities of different KPI's capable of being used. Thereafter, as shown at block 204, a step or logical operation can be provided for defining the difficulty of the proposed competition. Then, as illustrates at block 206, a step or logical operation can be implemented for defining the reward (e.g., amount of compensation) associated with the competition. Then, as depicted at block 208, a step or logical operation can be provided for definining the desired output of the competition. As shown next at block 210, a step or logical operation can be provided to provide the possibility of defining challenges among teams under specific conditions based on levels of progress reached.

The disclosed embodiments thus address problems encountered in managing competitions in work environments such as call centers by allowing their participants, (e.g., call center agents), to be involved in their definition. More specifically, the disclosed solution is based on the idea that agents participate in the definition of competitions that are centred primarily on difficulty. In order to appreciate the novelty and uniqueness of the disclosed solution, it is helpful to review a previous tool used in work environment competitions. Such a tool has been described (e.g., see U.S. Patent Application Publication No. 2014/0192970) for providing organizers of competitions with some flexible support for the design of competitions based on historical data of the call centres in terms of performance indicators and objectives.

Such a tool informs its users, in this case the organisers of the competitions, about the impact of having a given improvement on a given KPI as the objective of a competition on other KPIs. As an example, an improvement of AHT could in some cases have a negative impact on another metric, Customer Satisfaction scores (CSAT). Moreover, the tool provides its users with a representation of the relative difficulty of the configured competition in order to avoid the organisers launching a competition too difficult to be achieved or effective with respect to the current situation in the call centre and then likely to fail the objective of improving the call center performance.

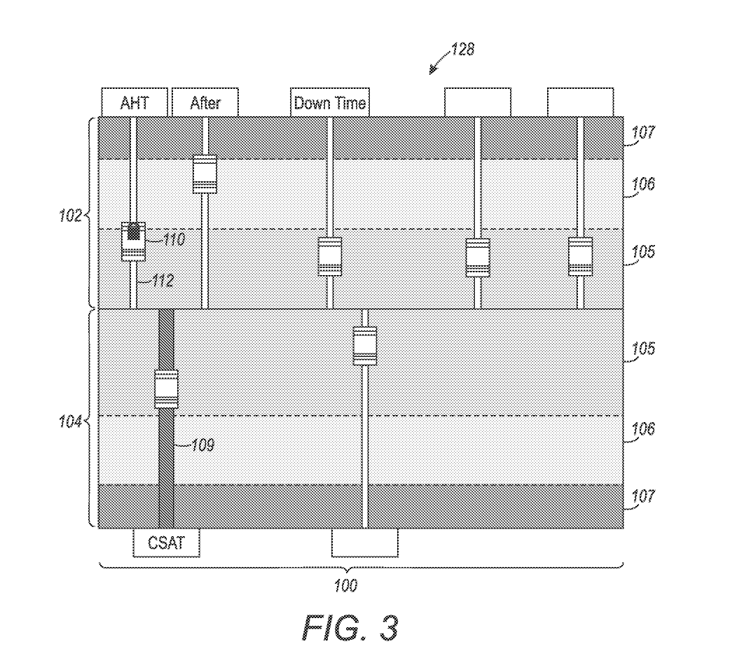

The difficulty is illustrated by showing the correlations among the KPIs and in particular the ones considered in the competition. This problem can be illustrated with respect to FIG. 3, which depicts example graphical representation of a visual interface 128 depicting an example of a configuration for a competition based on AHT improvement. FIG. 3 depicts an example of the configuration of a competition in the tool discussed in U.S. Patent Application Publication No. 2014/0192970, where the AHT is the main target of the competition and it has been lowered by its organiser to the desired value and then locked. As an effect, the CSAT has lowered as well and as the user moves the slider for the CSAT to a more acceptable value, the thickness and red hue of the slider increased as the relative difficulty of the challenge increases.

The visual interface 128 shown in FIG. 3 can be configured to display a decision making support tool 100 for the supervisor. The support tool 100 is illustrated with current performance metric values and horizontal regions.

In some embodiments, the tool 100 can be bifurcated with a plurality of performance metric controls 110 disposed on the interface which are each movable in a respective displayed range along a respective bar 112. The bifurcated tool 100 includes a first horizontal region 102 for displaying performance metrics where a lower value is generally desired, e.g., after call work time (“After”). One or more performance metrics may be displayed on the first horizontal region 102. The aggregated KPIs represented in this region all have a threshold value (e.g., a call center constraint) which agents should not exceed.

The bifurcated tool 100 can also include a second horizontal region 104 for displaying performance metrics where a higher value is generally desired, e.g., CSAT. One or more performance metrics may be displayed on the second horizontal region 104. The aggregated KPIs represented in this region all have a threshold value (e.g., a call center constraint) which agents should not fall below.

The tool 100 can be employed to assist supervisors within the work environment or call center to construct and define competitions. Particularly, these competitions may have the aim both to improve the performance of the call center and to motivate the agents to participate actively in the competitions.

The support tool 100 may be adapted to perform, for example, one or more of the following:

1. Automatically detect when the values of one or more aggregated KPI(s) trend towards violating a predetermined threshold (constraint(s)). The constraint(s) may be defined by one or more of the of the terms of the service level agreement (SLA) and the call center itself. The tool 100 also notifies the supervisor accordingly to suggest a design for a competition; and

2. Provide supervisors with both (1) the estimated effect of the competition on related aggregated KPIs and (2) information on current agents' performance and an estimation of “realistic” improvements. The estimated effect may be determined either by correlations detected by the system for forming contextualized competitions in a work environment or by the definition of the supervisors themselves. The estimation of realistic improvements may be calculated based on several factors including the compatibility of improvements to the selected KPIs within the agent's current individual objectives and skills.

The decision-making support tool 100 enables a supervisor to dynamically define competitions on the basis of current and past performance data collected in the call center. The tool 100 is designed to enhance the definition and targeting of competitions in the call centers.

With continuing reference to FIG. 3, the value of related aggregated KPIs at a current time can be visualized on visual interface 28. The interface 28 serves to inform supervisors as to the impact of a proposed change in one aggregated KPI on related aggregated KPIs. When a selected aggregated KPI is manipulated, e.g., by moving control 110 up or down on interface 100 along sliding member 112, KPIs that are related to the selected KPI will also change to represent the effect that the change in the selected KPI has on related KPIs.

Related KPIs can be grouped together to make viewing of the changes easier and help supervisors construct an accurate picture of how the KPIs are related. In addition to AHT, other related KPIs are represented on FIG. 3, such as “After” for After call work time, and “CSAT” for Customer Satisfaction Survey responses. The number of different KPIs that should be represented on interface 28 due to their relation with each other may range from 2 to 20. In one embodiment, between 5 to 10 related KPIs are represented on interface 28.

The different KPIs represented on interface 28 may be displayed in relation to their established individual thresholds as defined by, for example, the SLA and the call center. There are several horizontal regions 105, 106, 107 on bifurcated interface 28 which indicate a different KPI status. Regions 105, 106, 107 are associated with the different states of the KPIs relative to their respective established thresholds. KPI values falling within region 105 are considered to be in a “good” state. KPI values falling within region 106 have not yet violated the established KPI thresholds, but are deemed to be in a “warning” state. KPI values falling within region 107 are currently in violation of the established KPI thresholds. As will be appreciated, the transition between good and warning states may be set by the supervisor/call center or may be a function of the threshold, such as 50% or 70% of its value.

In order to display different KPIs, where each may have different units of measure and/or different threshold values, KPIs may be normalized so that the different thresholds are aligned on the visual interface 28. With reference to FIG. 3, if AHT and CSAT are both performance metrics measured in seconds and AHT violates the SLA at 120 seconds and CSAT violates the SLA at 60 seconds, the same distance on the interface will not represent the same amount of time, but may represent a corresponding proportion of that value.

When an issue with one or more KPIs is detected, the system can alert, for example, a supervisor 30 with a visual indicator or a communication as configured by the supervisor. Then the supervisor can start to design a competition with the objective of addressing the detected issue. The supervisor can do this using the system to define the improvements that will be needed on the problematic issues and studying the impact, if any, on other related KPIs.

In order to inform supervisors as to the impact of the proposed change to a KPI on other related KPIs, the user-operable selector controls associated with related KPIs will change, e.g., move up or down a sliding member 112, in the form of a vertical bar, as the supervisor is manipulating the control 110 for KPI that they would like to modify. The interface thus allows for predicted effects on related KPIs to be visualized by the supervisor. The sliding member 112 allows a user to variably select an acceptable level or target level of one (or more) of the KPIs between predetermined maximum and minimum values and thereby influence whether the system is more heavily weighted toward achieving that KPI or towards achieving other KPIs to the potential detriment of that KPI. For example, the user can operate the cursor control device 33 to click on the user operable control 110 of one of the sliding members 112. The user can drag the cursor along the sliding member 112 between the maximum and minimum levels to select a target KPI. The system 110 computes the effect this is predicted to have on related KPIs and automatically moves the corresponding controls to new positions on their respective slider bars 112.

FIG. 3 thus depicts an example of the configuration of a competition, where the AHT is the main target of the competition and it has been lowered by its organizer to the desired value and then locked. As an effect, the CSAT has lowered as well and as the user moves the slider for the CSAT to a more acceptable value, the thickness and red hue of the slider 109 increases as the relative difficulty of the challenge increased.

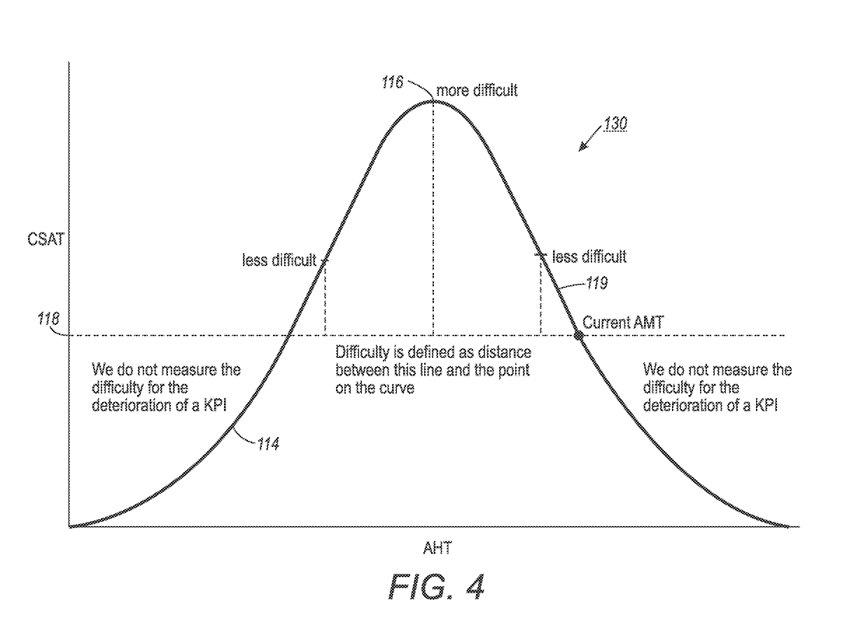

FIG. 4 illustrates a graph 130 depicting data indicative of how the difficulty of a simple competition can be calculated, in an example case. That is, graph 130 indicates that the order of difficulty of a proposed competition can be modeled as a non-linear relationship 114. For example, if AHT is decreased while CSAT is fixed at a current value, the difficulty of the competition will increase until the peak of the curve 116 is reached. If AHT is increased beyond 116, the difficulty of the competition will instead decrease.

In particular, the order of difficulty is indicated in FIG. 4 by the vertical distance between: 1) peak 116 on the non-linear relationship 114 and 2) the horizontal line 118 representing the value of CSAT according to non-linear model 114 when AHT is fixed at a current value 119. This non-linear relationship model for determining difficulty of a proposed competition may be applied to other performance metrics besides CSAT and AHT in a similar fashion. The graph 130 shown in FIG. 4 may be presented to a supervisor 30. for example, or simply used to generate a representation, such that as the supervisor moves the CSAT control, the level of difficulty computed according to the function illustrated in graph 130 is illustrated on the display.

The disclosed embodiments can be implemented to define a new mechanism that supports the design of competitions composed of a process wherein the organizer of a competition determines the “appropriate” range for its level of difficulty in collaboration with the participants to the competition, both implicitly through their participation in previous competitions and explicitly through mechanisms such as voting. This can serve the purpose of keeping the agents engaged and get their feedback on competition composition.

The primary factor that we envision agents considering when deciding the level of difficulty for a potential competition is the risk vs. the reward. Of course, there will be other extenuating circumstances that impact this decision (e.g., a new product release, new member on the team, etc.), but these are all in relation to the assessment of risk for a level of difficulty.

Other secondary factors involved in the construction of a competition can include, for example, the objective (e.g., reduce AHT), the type of competition (e.g., a race, a tournament, etc.), and the participants in the competition. Before proceeding, a review of three roles involved in the definition of competitions is helpful.

The Operations Manager's role is to define the overall parameters of the competition system. This is primarily accomplished through defining parameters for the KPIs such as the goals for each KPI and the available rewards. Also, the operation manager can define priorities for the KPIs. Each of these parameters is developed for a Season of competitions. The supervisor is the person responsible for overseeing the local instantiations of competitions for their team. A supervisor has the option to issue bonuses, consolation prizes, and reward multipliers based on team performance. The agent is the primary actor in the day-to-day operations of the system. Other than actually being the ones participating in the competitions, an agent typically makes choices about what to do during the current week.

In addition to understand the roles of the actors in a work environment as indicated above, concepts and/or terms should also be explained. Thus, a “competition” is focused on one KPI and is always the same length (although this length is configurable, as different call centres have different rhythms of work). A “season” constitutes a series of competitions and is of configurable length. Each season has its own set of constraints, which are primarily defined as parameters of the KPIs. A “team” is composed of agents grouped under an individual supervisor. Each “KPI Level” can be defined by an upper and lower bound value for the given KPI. A “Team Level” refers to the fact that each team has a level that indicates how far it has progressed through a season's progression. The term “progression” refers to the KPI levels and the prioritization that define the progression for a season.

In general, there are a number of processes that can be implemented in the context of ongoing definition of competitions. For example, a new season can be defined and the first competition launched (with a bonus) according to the following progression:
1. Operations Manager reviews the overall performance of the call centre.
2. Operations Manager defines the parameters for the new season of competition, including determining levels of difficulty of the competitions and prioritizing the objectives of the competitions, that is the KPIs associated to the competitions.
3. Supervisor provides various multipliers of rewards based on their team's individual performance.
4. Agents collaboratively vote on which level of difficulty, KPI, and competition type they will participate in, where the simple majority wins the voting process.
5. Supervisor monitors the competition and issues appropriate bonus/consolation prize for agents.

Progression through the group levels can be implemented as follows:
1. The availability of options can be determined by the current performance of the team.
2. As the team improves their performance, they gain access to more difficult, rewarding competitions.
3. In order to gain access to the most difficult and rewarding tier of competitions for each KPI, the team has to complete the team challenge for that KPI.
4. Once the team has progressed through all of the challenges for the KPIs, they will gain access to greater levels of configuration and the ability to challenge other teams.

The number of levels for each KPI can typically default to four, although this is configurable during the definition of the levels by the Operations Manager. A method for determining their default value can be based on several factors including the Service Level Agreement (SLA), historical performance data, and manual feedback from the Operations Manager. In this way, the levels represent both the goals of the call centre and the abilities of the call center agents.

To determine the default for each of the four levels, quartiles can be utilized to divide the population of agents. The process for determining these can be implemented as follows:

First, the target threshold values can be defined in the SLA, which may be used to determine the lower and upper bounds of reasonable expectations for the metrics. This can be accomplished by gathering two data points for each metric, the warning level and the error level, and then normalizing the values to obtain a generic value from a 0-100 range.

More specifically:
# first we get the unit, we put 40 points between the error and warning unit=(error_threshold−warning_threshold)/40.0
# then to transform a particular value (value−self.warning_threshold)/unit+30

Second, in order to divide these reasonable expectations into levels of difficulty, the four levels can be defined by the quartiles. The reasonable expectations are a fence of sorts on the computation of the quartile.

Lastly, the Operations Manager can review these levels and add, remove, change them as they see fit.

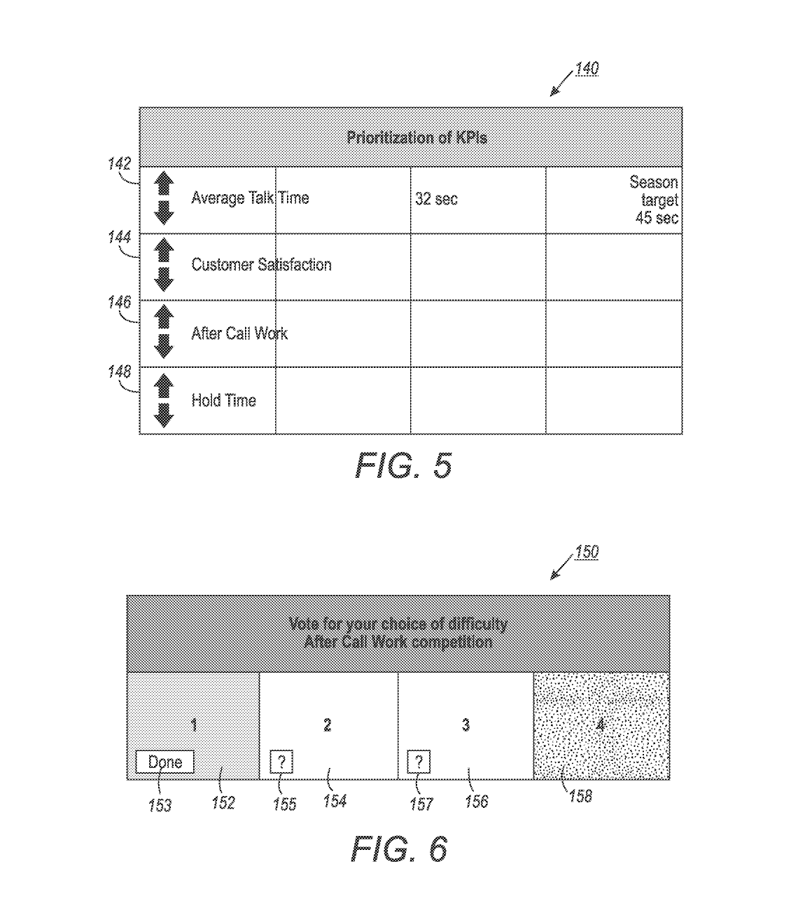

FIG. 5 illustrates an example interface 140 wherein an operation manager or other user can prioritize KPI's, in accordance with an embodiment. Note that similar interfaces such as those depicted in FIGS. 5-6 are also shown in U.S. Patent Application Publication No. 2014/0192970 albeit in a different context. Prioritization of KPI's can be implemented by utilizing one or more of the factors shown in FIG. 5, such as, for example, average talk time 142, customer satisfaction 144, after call work data 146, and hold time 148. The operations manager can prioritize the KPI's for a respective call center. Such a prioritization scheme impacts the order in which the call centre agents progress through a season. An operations manager can prioritize the KPIs, for example, via the interface 140 shown in FIG. 5.

In the interface 140 depicted in FIG. 5, the KPIs are displayed according to their current order of prioritization. For example, the “Average Talk Time” 142 is denoted as the most important metric among the four considered, followed by “Customer Satisfaction” 144, “After Call Work” 146, and “Hold Time” 148. Columns shown in interface 140 represent the level of difficulty and the depicted bands are indicative of the values of the KPIs corresponding to the level of difficulty denoted by the corresponding column. The operations manager can use graphically displayed arrows on the left side to change the priority of each KPI up or down. When the user or operations manager, for example, hovers the mouse over the KPI, the current value and the target value can be displayed.

FIG. 6 illustrates an example interface 150 that allows a participant or agent to select the particular level of difficulty in accordance with an alternative embodiment. The interface 150 includes four areas 152, 154, 156, and 158. Area 152 includes a graphically displayed button 153 labeled “Done” and area 2 includes a graphically displayed button 155 labeled with a question mark. Similarly, area 3 includes a graphically displayed button labeled 157 with a question mark. Note that the supervisors can be provided with the ability to influence the decisions about competitions through assigning multipliers to a given KPI. Such multipliers can be used to calculate or generate a bonus with respect to the amount of points/rewards earned by completing competitions for that KPI. For example, if a team does not select an important metric, a supervisor can render that metric more valuable to influence their choice.

Agents, on the other hand, can be provided with a voting mechanism for choosing the level of difficulty that they are available to consider. The way that agents explicitly choose from the available levels of difficulty for a given competition is shown in the interface 150 in FIG. 6. Possible levels are available for selection and the levels that have yet to be achieved are greyed out. In FIG. 6, the agent has selected a level 1 competition. In a real deployment, there will be more than one KPI. Voting is won by a simple majority,

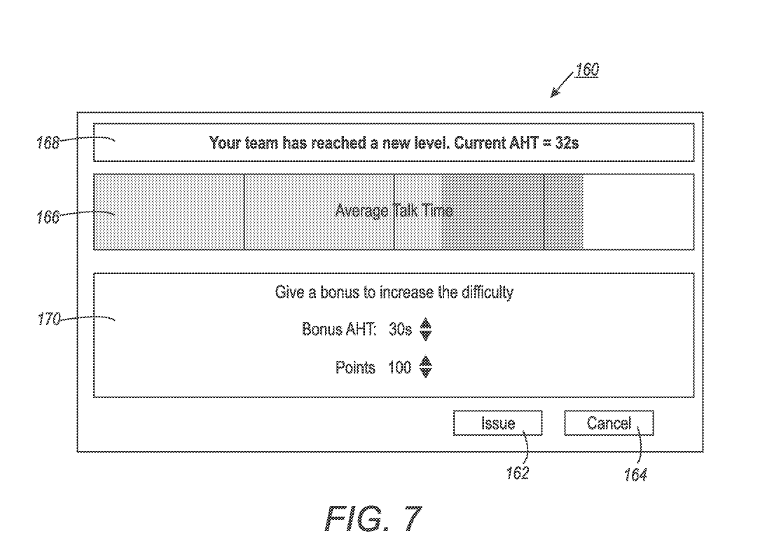

FIG. 7 illustrates an example interface 160 that can be utilized to assist a manager in deciding whether or not to issue a bonus, in accordance with an alternative embodiment. Interface 7 includes, for example, a graphically displayed “Issue” button 162 and a cancel button 164. An area 170 of interface 160 allows a user to give a bonus to increase the difficulty. Average talk time is indicated in area 166. An announcement 168 indicates in the example of FIG. 7 that “Your team has reached a new level. Current AHT=32 s.”

An additional explicit way that managers help to define the level of difficulty for agents is to give bonuses to the different levels of difficulty based on the current situation of the call centre. For example, if the client organization is releasing a new product or there is pressure to improve a certain metric, the rewards for different levels of difficulty can be adjusted or multiplied to encourage their selection.

Within a competition, if a group is doing particularly well or poorly, the manager can issue a bonus. In this way, the difficulty can be increased or decreased during the competition hopefully increasing the amount of engagement from the agents and decreasing the boredom within the competitions that are too difficult or easy. The interface 160 shown in FIG. 7 can thus assist the manager in deciding whether or not to issue a bonus.

The top part of the interface 160 identifies which value of a KPI has reached the target fixed in a current competition. The lower part of the interface 160 offers to the manager the possibility to rise up this target while allocating a bonus in case this new target value was attained. The new target value and the bonus value are both tuneable. Finally, the manager can validate his or her choices, but alternatively simply cancel this bonus offer and the associated target raise, by clicking on the Cancel button 164.

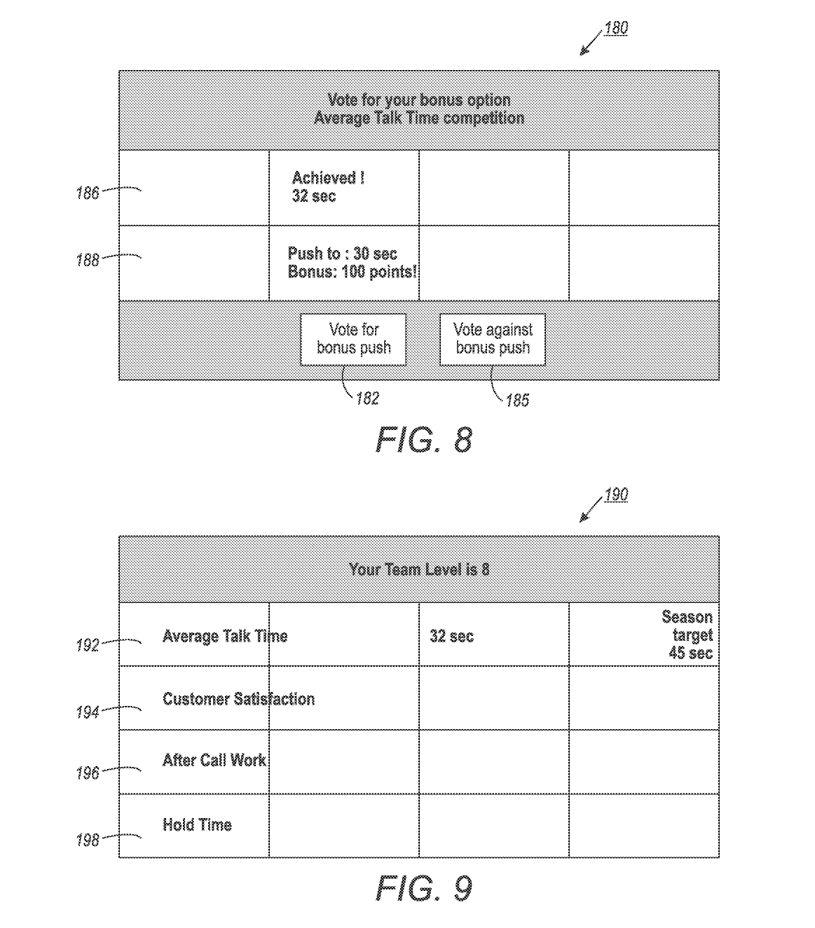

FIG. 8 illustrates an example interface 180 that allows an agent to vote to accept or reject a bonus, in accordance with an alternative embodiment. The changing of a competition while it is still in progress must be handled with care. Bonuses allow the manager of a team an additional method for engaging with his or her employees. That is, if one or more of the employees chooses to not take part in the bonus, the original ‘contract’ of the competition is not violated.

Agents can vote to accept or reject a bonus as shown in interface 180. The use of interface 180 follows the issue of a bonus by a manager, as shown in FIG. 8. Most of the interface provides information about the KPI concerned here, the target that was successfully reached, and the new target issued by a manager with its associated bonus. Each agent has time to ponder about accepting this bonus for this new challenge, and vote for or against it in the lower part of the interface. Graphically displayed button 182, when selected or “clicked” by a user allows for a vote for a bonus push, whereas graphically displayed button 185, when selected or “clicked” by a user, allows for a vote against a bonus push. Areas 186 and 188 respectively display time and push/bonus data.

FIG. 9 illustrates an example interface 190 that can permit visualization of the progress of a team in work environment competition, in accordance with an alternative embodiment. Part of the implicit, collective definition of competitions will be done through a progression through the predefined levels of difficulty from the previous section. As a team of agents under a supervisor improves their KPIs, they will be able to choose from progressively more difficult competitions. The competition organiser will define this progression, in that they will define the order of the KPIs according to their importance to the call center.

The interface 190 shown in FIG. 9 provides for the visualisation of progression for a team, aimed at the team's supervisor or manager. Each cell is a level and each row a KPI. A row can be completely colored to represent the highest fulfillment of the highest level, if the value of the KPI had reached the season target, fixed beforehand by the manager. This interface does not offer any action lever, only visualization of progression towards season targets. The example interface 190 displays data indicative of “Average Talk Time” 192, “Customer Satisfaction” 194, “After Call Work” 196, and “Hold Time” 198.

Note that as teams progress through the levels of a season, they will gain more choices and control over their competitions and rewards. The operations manager will determine the rewards for each level. The different rewards include: the different difficulties that will become available; increasingly varied rewards; ability to choose which type of competition (with increasing options as a team progresses); and finally, once the progression has been nearly completed the ability to challenge another team.

Once a team has finished its progression, the team can configure a competition (e.g., type, KPI, target value, reward) and use this to challenge another team. Each of these four configurations can be accomplished through a voting mechanism, such as, for example, the interfaces depicted herein.

A novel solution is thus disclosed for defining the difficulty of metric based competitions in a call center as a result of a collaborative process involving the organizers and the participants of the competitions, which encapsulates methods and/or steps to, for example, determine the priorities of the different KPIs that can be used, the difficulty of the proposed competition, the reward (e.g., the amount of compensation) associated with the competition, define the desired outcome of the competition; and provide for the possibility of defining challenges among teams under specific conditions based on levels of progression reached.

Based on the foregoing, it can be appreciated that a number of embodiments, preferred and alternative, are disclosed herein. For example, in one embodiment, a method can be implemented for managing a metric-based competition in a work environment to increase productivity. Such a method can include the steps or logical operations of, for example, receiving information related to a set of participants in a work environment; and generating at least one interface that allows participants to input data for use in collaboratively defining key performance indicators associated with a proposed competition and based at least in part on the information related to the participants, so as to increase participant motivation by providing the participants with more agency and choice with respect to competitions in the work environment.

In another embodiment, a step or logical operation can be provided for determining priorities of different key performance indicators capable of being used in the proposed competition. In still another embodiment, a step or logical operation can be provided for defining a difficulty of the proposed competition. In another embodiment, a step or logical operation can be implemented for defining a reward associated with the proposed competition. In still another embodiment, a step or logical operation can be implemented for presenting options via the interface for inputting the data for use in defining challenges under particular conditions based on levels of progression attained. In some embodiments, the work environment may be, for example, a call center. The aforementioned participant may be, for example, a manager or an agent associated with the work environment.

In another embodiment, a system for managing a metric-based competition in a work environment to increase productivity can be implemented. Such a system can include, for example, a processor; and a non-transitory computer-usable medium embodying computer program code, the non-transitory computer-usable medium capable of communicating with the processor. Such computer program code can include instructions executable by the processor and configured, for example, for receiving information related to a set of participants in a work environment; and generating one or more interfaces that allows participants to input data for use in collaboratively defining key performance indicators associated with a proposed competition and based at least in part on the information related to the participants, so as to increase participant motivation by providing the participants with more agency and choice with respect to competitions in the work environment.

In another system embodiment, such instructions can be further configured for determining priorities of different key performance indicators capable of being used in the proposed competition. In yet another embodiment, such instructions can be further configured for defining a difficulty (e.g., a level of difficulty) of the proposed competition. In still another embodiment, such instructions can be further configured for defining a reward associated with the proposed competition. In still another embodiment, such instructions can be further configured for presenting options via the interface(s) for inputting the data for use in defining challenges under particular conditions based on levels of progression attained.

In yet another embodiment, a processor-readable medium storing code representing instructions to cause a process for managing a metric-based competition in a work environment to increase productivity can be implemented. Such code can include code to, for example: receive information related to a set of participants in a work environment; and generate at least one interface that allows participants to input data for use in collaboratively defining key performance indicators associated with a proposed competition and based at least in part on the information related to the participants, so as to increase participant motivation by providing the participants with more agency and choice with respect to competitions in the work environment.

In another embodiment, such code can further include code to determine priorities of different key performance indicators capable of being used in the proposed competition. In still another embodiment, such code can include code to to define the difficulty of the proposed competition. In still another embodiment, such code can include code to define a reward associated with the proposed competition. In another embodiment, such code can include code to present options via the at least one interface for inputting the data for use in defining challenges under particular conditions based on levels of progression attained.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for managing a metric-based competition in a work environment to increase productivity, said method comprising:
receiving information related to a set of participants in a work environment; and
generating at least one interface that allows participants to input data for use in collaboratively defining key performance indicators associated with a proposed competition and based at least in part on said information related to said participants, so as to increase participant motivation by providing said participants with more agency and choice with respect to competitions in said work environment.

2. The method of claim 1 further comprising determining priorities of different key performance indicators capable of being used in said proposed competition.

3. The method of claim 1 further comprising defining a difficulty of said proposed competition.

4. The method of claim 1 further comprising defining a reward associated with said proposed competition.

5. The method of claim 1 further comprising:
providing options via said at least one interface for inputting said data for use in defining challenges under particular conditions based on levels of progression attained.

6. The method of claim 1 wherein said work environment comprises a call center.

7. The method of claim 1 wherein said participant comprises at least one of: a manager or an agent associated with said work environment.

8. A system for managing a metric-based competition in a work environment to increase productivity, said system comprising:
a processor; and
a non-transitory computer-usable medium embodying computer program code, said non-transitory computer-usable medium capable of communicating with the processor, said computer program code comprising instructions executable by said processor and configured for:
receiving information related to a set of participants in a work environment; and
generating at least one interface that allows participants to input data for use in collaboratively defining key performance indicators associated with a proposed competition and based at least in part on said information related to said participants, so as to increase participant motivation by providing said participants with more agency and choice with respect to competitions in said work environment.

9. The system of claim 8 wherein said instructions are further configured for determining priorities of different key performance indicators capable of being used in said proposed competition.

10. The system of claim 8 wherein said instructions are further configured for defining a difficulty of said proposed competition.

11. The system of claim 8 wherein said instructions are further configured for defining a reward associated with said proposed competition.

12. The system of claim 8 wherein said instructions are further configured for:
providing options via said at least one interface for inputting said data for use in defining challenges under particular conditions based on levels of progression attained.

13. The system of claim 8 wherein said work environment comprises a call center.

14. The system of claim 8 wherein said participant comprises at least one of: a manager or an agent associated with said work environment.

15. The system of claim 14 wherein said instructions are further configured for:
defining a reward associated with said proposed competition; and
providing options via said at least one interface for inputting said data for use in defining challenges under particular conditions based on levels of progression attained.

16. A processor-readable medium storing code representing instructions to cause a process for managing a metric-based competition in a work environment to increase productivity, said code comprising code to:
receive information related to a set of participants in a work environment; and
generate at least one interface that allows participants to input data for use in collaboratively defining key performance indicators associated with a proposed competition and based at least in part on said information related to said participants, so as to increase participant motivation by providing said participants with more agency and choice with respect to competitions in said work environment.

17. The processor-readable medium of claim 16 wherein said code further comprises code to determine priorities of different key performance indicators capable of being used in said proposed competition.

18. The processor-readable medium of claim 16 wherein said code further comprises code to define a difficulty of said proposed competition.

19. The processor-readable medium of claim 16 wherein said code further comprises code to define a reward associated with said proposed competition.

20. The processor-readable medium of claim 16 wherein said code further comprises code to present options via said at least one interface for inputting said data for use in defining challenges under particular conditions based on levels of progression attained.
